(19) United States
(12) Patent Application Publication
(10) Pub. No.: US 2013/0042426 A1
(43) Pub. Date: Feb. 21, 2013

(54) ELECTRONIC VEHICLE WIPER BLADE PARKING MECHANISM

(71) Applicants: SCOTT R. WEBB, MACOMB TOWNSHIP, MI (US); NICHOLAS W. PINTO, IV, FERNDALE, MI (US); PAUL W. ALEXANDER, YPSILANTI, MI (US); XIUJIE GAO, TROY, MI (US); WENDELL G. SUMMERVILLE, BIRMINGHAM, MI (US); SCOTT P. CHARNESKY, BIRMINGHAM, MI (US); THOMAS W. COX, LAPEER, MI (US); KHRISTOPHER S. LEE, OAKLAND TOWNSHIP, MI (US)

(72) Inventors: SCOTT R. WEBB, MACOMB TOWNSHIP, MI (US); NICHOLAS W. PINTO, IV, FERNDALE, MI (US); PAUL W. ALEXANDER, YPSILANTI, MI (US); XIUJIE GAO, TROY, MI (US); WENDELL G. SUMMERVILLE, BIRMINGHAM, MI (US); SCOTT P. CHARNESKY, BIRMINGHAM, MI (US); THOMAS W. COX, LAPEER, MI (US); KHRISTOPHER S. LEE, OAKLAND TOWNSHIP, MI (US)

(73) Assignee: GM GLOBAL TECHNOLOGY OPERATIONS LLC, DETROIT, MI (US)

(21) Appl. No.: 13/211,364

(22) Filed: Aug. 17, 2011

(51) Int. Cl. B60S 1/08

(52) U.S. Cl. 15/250.17

(57) ABSTRACT

A vehicle wiper assembly includes a wiper blade configured to wipe a surface, an armature, and an actuator. The armature has a first end spaced from a second end, and is coupled with the wiper blade at the first end, and coupled to a pivot mechanism at the second end. The pivot mechanism is configured to allow the wiper blade to articulate about the second end in a direction substantially away from the surface and between a wiping position and a parked position. The actuator is provided in mechanical communication with the armature and is configured to receive an electrical actuation signal to transition the wiper blade between a wiping position and the parked position, where the wiper blade is in contact with the surface while in the wiping position, and is separated from the surface while in the parked position.

### TECHNICAL FIELD

The present invention relates to vehicle wiper blade assemblies.

### BACKGROUND

A vehicle wiper assembly is a device used to remove liquid, such as rain, and/or debris from the surface of a vehicle window. Often wiper assemblies are used in conjunction with the front windshield/windscreen of the vehicle and/or a rear window of the vehicle. Vehicles that may employ the use of wiper assemblies may include, for example, automobiles, trains, aircrafts and watercrafts.

A wiper assembly may generally include a long wiper blade that is swung back and forth over the surface of the glass to push water from its surface. The speed is normally adjustable, with several continuous speeds and often one or more “intermittent” settings. Also, the blade may be adapted to conform to any varying curvature that may be present along the surface of the window.

During inclement weather, especially in colder climates, rain or melted snow may accumulate on the wiper blade, where it may freeze to ice. Accumulated ice may detract from the blade's ability to conform to a varying surface curvature or wiping ability. Additionally, the wiper blade may freeze to the surface of the window if left in stationary contact with the surface during, for example, a snow storm. Removing the blade from its frozen condition may tend to cause damage to the blade, which may result in reduced wiping performance.

### SUMMARY

A vehicle wiper assembly includes a wiper blade configured to wipe a surface, an armature, and an actuator. The armature has a first end spaced from a second end, and is coupled with the wiper blade at the first end, and coupled to a pivot mechanism at the second end. The pivot mechanism is configured to allow the wiper blade to articulate about the second end in a direction substantially away from the surface and between a wiping position and a parked position. The actuator is provided in mechanical communication with the armature and is configured to receive an electrical actuation signal that transitions the wiper blade between a wiping position and the parked position, wherein the wiper blade is in contact with the surface while in the wiping position, and is separated from the surface while in the parked position.

In an embodiment, the actuator may include a shape memory alloy material having a crystallographic phase that is changeable between austenite and martensite in response to the electrical actuation signal. For example, the shape memory alloy material may be formed into a wire that has a length, where the wire is configured to contract in length in response to the electrical actuation signal. The wire may be in mechanical communication with the armature, and the contraction of the length of the wire may be configured to urge the armature to articulate about the second end.

In one configuration, the actuator may include an extendable riser disposed between the armature and the surface, wherein the riser has a height that is transitionable between a nominal position and an extended position in response to the electrical actuation signal. As such, the extendable riser may be operative to lift a portion of the armature when transitioned to the extended position.

In another configuration, the actuator may include an articulating stand disposed between the armature and the surface. The stand may be configured to articulate between a collapsed position and a standing position in response to the electrical actuation signal, where it is operative to lift a portion of the armature when articulated to the standing position.

In yet another configuration, the vehicle wiper assembly may further include a rotary hub coupled to the second end of the armature. The rotary hub may have an axis of rotation and be configured to articulate the wiper blade about the second end and in a direction substantially along the surface. The actuator may include the rotary hub, where the rotary hub is additionally configured to translate along the axis of rotation to transition the wiper blade between the wiping position and the parked position.

The vehicle wiper assembly may include a controller that is configured to provide the electrical actuation signal to the actuator in response to a key-off event or a user event. Additionally, the pivot mechanism may include a locking mechanism that is configured to selectively maintain the wiper blade in the parked position.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective illustration of a vehicle wiper assembly disposed in a wiping position in contact with a surface.

FIG. 2 is a perspective illustration of a vehicle wiper assembly disposed in a parked position separate from the surface.

FIG. 3 is a schematic side view of an embodiment of a vehicle wiper assembly including a tendon-type actuator.

FIG. 4 is a schematic side view of an embodiment of a vehicle wiper assembly including a selectively extendable riser.

FIG. 5 is a schematic side view of an embodiment of a vehicle wiper assembly including a selectively articulating stand.

FIG. 6 is a schematic side view of an embodiment of a vehicle wiper assembly including a selectively translatable rotary hub.

### DETAILED DESCRIPTION

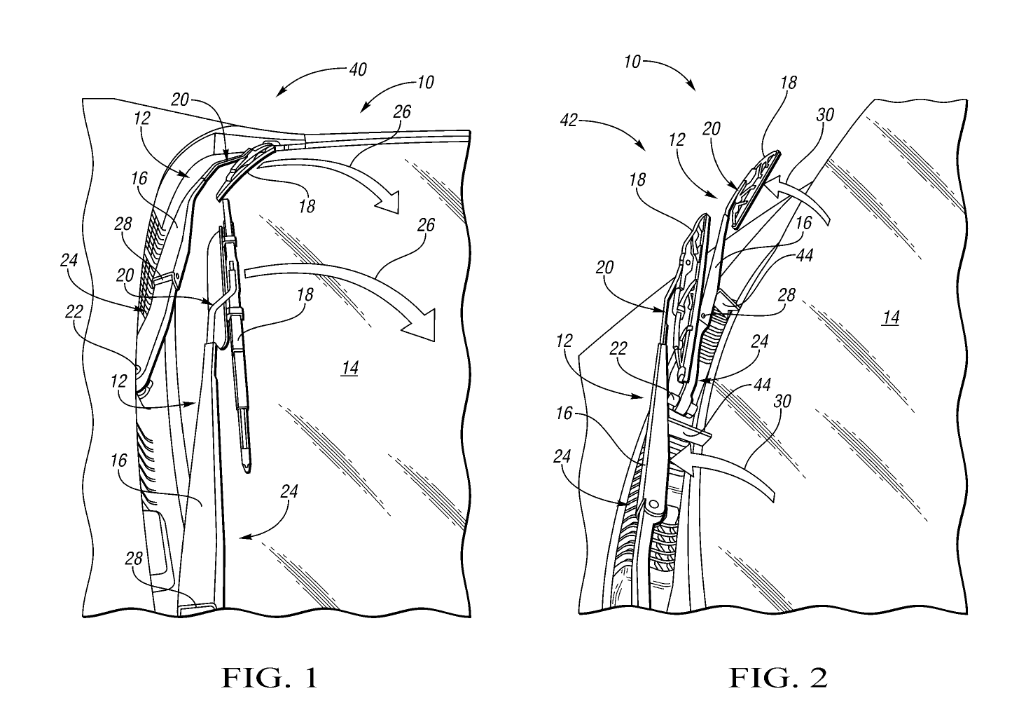

Referring to the drawings, wherein like reference numerals are used to identify like or identical components in the various views, FIG. 1 schematically illustrates a vehicle 10 having a pair of wiper assemblies 12 configured to wipe a liquid across the surface 14 of a window.

Each wiper assembly 12 may include an armature 16 that may be coupled to a wiper blade 18 at a first end 20 and coupled to a rotary hub 22 at a second end 24. The rotary hub 22 may have an axis of rotation that is substantially normal to the surface 14, and may be configured to articulate the wiper blade 18 along the surface 14 in an arc-shaped path 26. Such a motion may, for example, allow the wiper blade 18 to push liquid or debris toward the perimeter of the surface 14 of the window.

The armature 16 may further include a pivot mechanism 28 coupled to the second end 24, which may allow the armature 16 and wiper blade 18 to articulate in a direction 30 substantially away from the surface 14 as generally illustrated in FIG. 2. Such an articulation may be generally made about the second end 24, and may transition the wiper blade 18 between a wiping position (generally illustrated at 40 in FIG. 1) and a parked position (generally illustrated at 42 in FIG. 2). The pivot mechanism 28 may additionally be configured to selectively hold and/or maintain the wiper blade 18 in either the parked 42 or wiping 40 position, such as through the use of detents, latches, or other similar holding/locking means. For example, a spring may be used to hold the wiper blade 18 in the wiping position 40. While in the wiping position 40, the wiper blade 18 may generally be in contact with the surface 14 along its entire length. Thus, motion along the arc-shaped path 26 while the wiper blade 18 is in the wiping position 40 may be effective to clear liquid or debris from the surface 14. Conversely, while the wiper blade 18 is in the parked position 42, the wiper blade 18 may be substantially separated, or positioned apart from the surface 14. As further illustrated in FIG. 2, to lift and/or maintain the armature 16 and wiper blade 18 in the parked position, a stand 44 may extend between the surface 14 and the armature 16.

When parking the vehicle in cold, wet weather conditions, separating the wiper blade 18 from the surface 14 (i.e., in the parked position 42), may prevent the blade 18 from freezing to the surface 14. Similarly, when in hot weather conditions, the parked position 42 may prevent the blade 18 from permanently deforming against the surface 14 such as when the blade 18 may be softened from the heat.

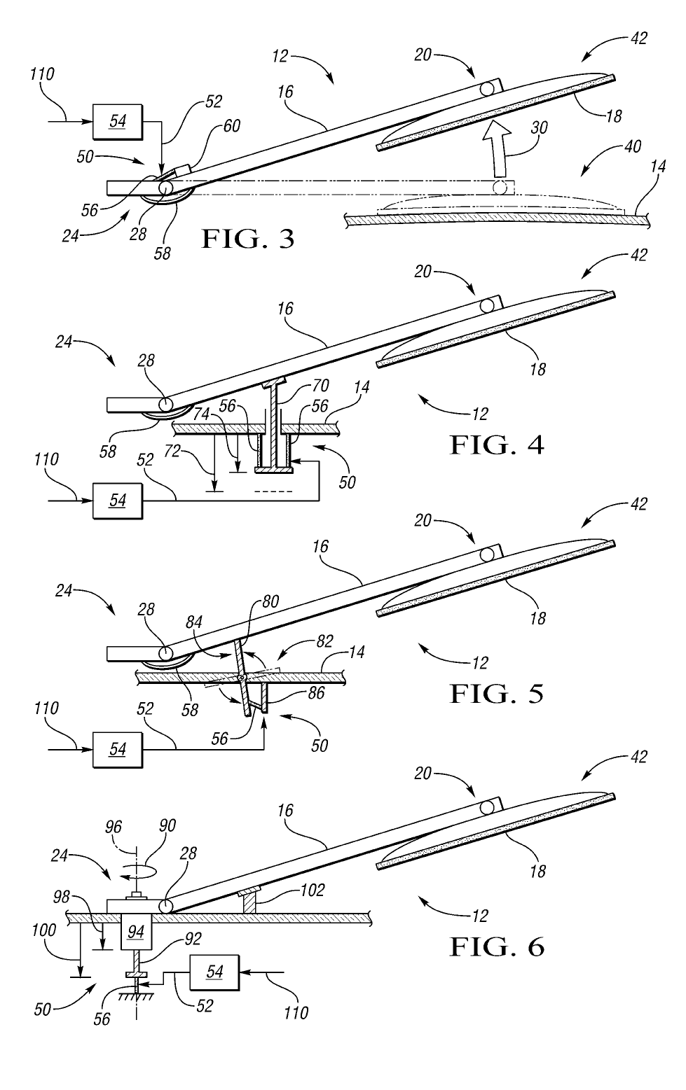

As generally illustrated in FIGS. 3-6, an actuator 50 may be in mechanical communication with the armature 16, and may be configured to transition the wiper blade 18 between the wiping position 40 and the parked position 42. The actuator 50 may be configured to receive an electrical actuation signal 52 from a controller 54, and transition the wiper blade 18 in response to the signal 52. While the actuator 50 may take various forms, in one configuration, it may include a shape memory alloy material 56 with a crystallographic phase that is changeable between austenite and martensite in response to the electrical actuation signal 52.

As used herein, the terminology “shape memory alloy” (often abbreviated as “SMA”) refers to alloys which exhibit a shape memory effect. That is, the shape memory alloy material 56 may undergo a solid state, crystallographic phase change to shift between a martensite phase, i.e., “martensite”, and an austenite phase, i.e., “austenite.” Alternatively stated, the shape memory alloy material 56 may undergo a displacive transformation rather than a diffusional transformation to shift between martensite and austenite. A displacive transformation is a structural change that occurs by the coordinated movement of atoms (or groups of atoms) relative to their neighbors. In general, the martensite phase refers to the comparatively lower-temperature phase and is often more deformable than the comparatively higher-temperature austenite phase.

The temperature at which the shape memory alloy material 56 begins to change from the austenite phase to the martensite phase is known as the martensite start temperature, Mₛ. The temperature at which the shape memory alloy material 56 completes the change from the austenite phase to the martensite phase is known as the martensite finish temperature, M_{f}. Similarly, as the shape memory alloy material 56 is heated, the temperature at which the shape memory alloy material 56 begins to change from the martensite phase to the austenite phase is known as the austenite start temperature, Aₛ. The temperature at which the shape memory alloy material 56 completes the change from the martensite phase to the austenite phase is known as the austenite finish temperature, A_{f}.

Therefore, the shape memory alloy material 56 may be characterized by a cold state, i.e., when a temperature of the shape memory alloy material 56 is below the martensite finish temperature M_{f} of the shape memory alloy material 56. Likewise, the shape memory alloy material 56 may also be characterized by a hot state, i.e., when the temperature of the shape memory alloy material 56 is above the austenite finish temperature A_{f} of the shape memory alloy material 56.

In operation, shape memory alloy material 56 that is pre-strained or subjected to tensile stress can change dimension upon changing crystallographic phase to thereby convert thermal energy to mechanical energy. That is, the shape memory alloy material 56 may change crystallographic phase from martensite to austenite and thereby dimensionally contract if pseudoplastically pre-strained so as to convert thermal energy to mechanical energy. Conversely, the shape memory alloy material 56 may change crystallographic phase from austenite to martensite and if under stress thereby dimensionally expand so as to also convert thermal energy to mechanical energy.

Pseudoplastically pre-strained refers to stretching of the shape memory alloy material 56 while in the martensite phase so that the strain exhibited by the shape memory alloy material 56 under that loading condition is not fully recovered when unloaded, where purely elastic strain would be fully recovered. In the case of the shape memory alloy material 56, it is possible to load the material such that the elastic strain limit is surpassed and deformation takes place in the martensitic crystal structure of the material prior to exceeding the true plastic strain limit of the material. Strain of this type, between those two limits, is pseudoplastic strain, called such because upon unloading it appears to have plastically deformed. However, when heated to the point that the shape memory alloy material 56 transforms to its austenite phase, that strain can be recovered, returning the shape memory alloy material 56 to the original length observed prior to application of the load.

The shape memory alloy material 56 may be stretched before installation into the actuator 50, such that a nominal length of the shape memory alloy material 56 includes recoverable pseudoplastic strain. Alternating between the pseudoplastic deformation state (relatively long length) and the fully-recovered austenite phase (relatively short length) may apply a force that may be used to lift the wiper blade 18.

The shape memory alloy material 56 may change both modulus and dimension upon changing crystallographic phase to thereby convert thermal energy to mechanical energy. More specifically, the shape memory alloy material 56, if pseudoplastically pre-strained, may dimensionally contract upon changing crystallographic phase from martensite to austenite and may dimensionally expand, if under tensile stress, upon changing crystallographic phase from austenite to martensite to thereby convert thermal energy to mechanical energy. Therefore, if the shape memory alloy material 56 is resistively heated via an electrical actuation signal 52, it may dimensionally contract upon changing crystallographic phase between martensite and austenite.

The shape memory alloy material 56 may have any suitable composition. In particular, the shape memory alloy material 56 may include an element selected from the group including, without limitation: cobalt, nickel, titanium, indium, manganese, iron, palladium, zinc, copper, silver, gold, cadmium, tin, silicon, platinum, gallium, and combinations thereof. For example, and without limitation, suitable shape memory alloys 56 may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations thereof.

The shape memory alloy material 56 can be binary, ternary, or any higher order so long as the shape memory alloy material 56 exhibits a shape memory effect, i.e., a change in shape orientation, damping capacity, and the like. The specific shape memory alloy material 56 may be selected according to expected operating temperatures that the wiper assembly 12 will be used with. In one specific example, the shape memory alloy material 56 may include nickel and titanium.

In other embodiments, the actuator 50 may include motors, solenoids, or other actuation means that may be responsive to an electrical actuation signal 52. While FIGS. 3-6 illustrate various types of actuators, these embodiments should be regarded as illustrative rather than exclusive. As may be appreciated, the shape memory alloy material 56 may be suitably replaced with other linear actuation means. Alternatively, the pivot mechanism 28 may be directly coupled to and/or include various direct drive motors, geared motors, or other similar drive mechanisms.

In an embodiment, the wiper assembly 12 may further include a return mechanism 58 that may be configured to transition the blade 18 from the parked position 42 to the wiping position 40. The return mechanism 58 may include, for example, a spring or an actuator that may apply a force to the armature 16 in such a manner to rotate the armature 16 and wiper blade 18 about the pivot mechanism 28 in a direction toward the surface 14. In one configuration, the return mechanism 58 may be configured to provide a gradual return force to controllably return the assembly 12 to the wiping position 40. In another configuration, the return mechanism 58 may apply a strong enough force for debris or ice to be knocked loose of the wiper blade 18 when the blade 18 strikes the surface 14. As such, the parking mechanism may be used as a de-icing apparatus.

Referring specifically to FIG. 3, a wiper assembly 12 is schematically illustrated, where the wiper assembly 12 includes a wiper blade 18 coupled with a first end 20 of an armature 16. The armature 16 may further include a pivot mechanism 28 coupled at the second end 24. FIG. 3 illustrates the wiper assembly 12 disposed in a parked position 42, though having been transitioned in a direction 30 substantially away from the surface 14, from a wiping position 40.

As schematically illustrated in FIG. 3 the actuator 50 may include a shape memory alloy material 56 that is disposed across the pivot mechanism 28 in a tendon-like arrangement. In one configuration, the shape memory alloy material 56 may be coupled to a riser 60 that may extend from the armature to enhance the mechanical leverage of the actuator 50. In another embodiment, a second riser may similarly be disposed on the opposing side of the pivot mechanism 28 to further increase the mechanical leverage of the actuator 50.

The shape memory alloy material 56 may be formed as a wire, which has a length configured to contract in response to an electrical actuation signal 52. In one configuration, the electrical actuation signal 52 may be provided by a controller 54 that may be in electrical communication with the actuator 50. As such, the wire may be pseudoplastically pre-stretched while in a martensite phase, with the wiper assembly 12 in a wiping position 40. Upon receipt of the electrical actuation signal 52, the phase of the shape memory alloy material 56 may change to austenite, wherein the pseudoplastic strain may be recovered. The reduction in the length of the shape memory alloy material 56 may correspondingly urge the armature 16 to articulate about the second end 24 (i.e., the pivot mechanism 28). As may be appreciated, the articulation of the armature 16 may transition the wiper blade 18 between the wiping position 40 in contact with the surface 14, and the parked position 42 separate from the surface 14.

FIG. 4 is a schematic illustration of a wiper assembly 12 that includes an actuator 50 configured to lift a portion of the armature 16. As shown, the actuator 50 may be disposed between the surface 14 and the armature 16, and may include an extendable riser 70 adapted to mechanically engage and apply a lifting force to the armature 16. In one configuration, the riser 70 may selectively transition between a nominal position 72 and an extended position 74. In the nominal position 72, for example, the riser 70 may be generally situated apart from the armature 16 and/or in a configuration where the riser 70 applies substantially no upward lifting force to the armature 16. In the extended position 74, the riser 70 may extend upward from the surface 14 to such a degree where it may hold the armature 16 and wiper blade 18 in a parked position 42.

The actuator 50 may be configured to transition between the nominal position 72 and the extended position 74 in response to an electrical actuation signal 52, such as one provided by a controller 54. During the transition, the riser 70 may mechanically engage the armature 16, and may further urge it to articulate away from the surface 14 and about the second end 24. In one embodiment, the actuator 50 may include, for example, one or more actuator elements that may each comprise a respective shape memory alloy material 56. In another embodiment, the actuator 50 may include one or more other linear-type actuators, such as, for example, solenoids, rack and pinion mechanisms, linear screws, electrically controlled pneumatics or hydraulics, or other similarly situated actuators.

As schematically illustrated, the shape memory alloy material 56 may be disposed between the riser 70 and the surface 14. In such an embodiment, the shape memory alloy material 56 may be pseudoplastically pre-strained and configured to contract in length when transitioned into an austenite phase (e.g., when it is resistively heated by the electrical actuation signal 52). As may be appreciated, other similar configurations may be employed to enable the riser 70 to extend from the surface 14 in response to the electrical actuation signal 52.

FIG. 5 schematically illustrates an embodiment of a windshield wiper assembly 12, where the actuator 50 includes an articulating stand 80 disposed between the armature 16 and the surface 14. The stand 80 may be configured to articulate between a collapsed position 82 (i.e., substantially parallel with the surface), and a standing position 84, where the stand 80 may be operative to lift a portion of the armature 16 when articulated to the standing position 84 (as shown). The stand 80 may transition between the collapsed position 82 and the standing position 84 in response to an electrical actuation signal 52 that may be provided from a controller 54.

In one configuration, the actuator 50 may include a shape memory alloy material 56 that may be coupled between, for example, a riser 86 and the articulating stand 80. The shape memory alloy material 56 may be pseudoplastically pre-strained while in the collapsed position 82, however, may recover that strain and contract in length when transitioned to an austenite phase (e.g., through resistive heating). In other configurations, other rotary or linear actuators may be used to transition the stand 80 between the collapsed position 82 and the standing position 84. For example, a motor may be coupled to the central hub of the articulating stand 80, either directly, or through one or more gears, belts, or pulleys, to selectively articulate the state 80. When transitioned to a standing position 84, the stand 80 may mechanically contact the armature 16, and urge it to pivot away from the surface 14.

While FIGS. 4 and 5 schematically illustrate the actuator 50 positioned on the surface 14 and configured to extend up to the armature 16, it is equally possible to position the actuator 50 on the armature 16, where it would be configured to extend down to contact the surface 14 and apply the lifting force.

FIG. 6 schematically illustrates an embodiment of a wiper assembly 12 that integrates the actuator 50 with the rotary hub 22 that may articulate the wiper blade 18 along the surface 14 in an arc-shaped path 26 (as generally described above with reference to FIG. 1). As schematically illustrated, the rotary hub 22 may be configured to impart a rotary motion 90 to a drive axle 92 which may be directly joined to the armature 16. The drive axle 92 may be disposed within a drive means 94 that is configured to impart the rotary motion 90 to the axle 92 about an axis of rotation 96. In one embodiment, the drive axle 92 may be a rotor disposed within a stator. In other embodiments, however, various cam mechanisms and/or linkages may alternatively or additionally be employed as the drive means 94 to articulate the drive axle 92.

As generally provided in FIG. 6, the drive axle 92 may be configured to translate within the drive means 94 and along the axis of rotation 96. This translation may generally be made between a first position 98 and a second position 100. As the drive axle 92 translates, it may be rigidly coupled with the armature 16 such that the armature 16 will correspondingly translate along the axis of rotation 96, which may be normal to the surface 14. A downward/inward translation of the armature 16 relative to the surface may then cause the armature 16 to pivot about a riser 102, which may extend from the surface 14. Similarly, the actuation may cause a corresponding pivot motion about the pivot mechanism 28.

The translation of the drive axle 92 may be caused by the actuator 50, which may include, for example, a shape memory alloy material 56 responsive to an electrical actuation signal 52 provided by a controller 54. In other configurations, the actuator 50 may include other types of liner actuators, including, for example, solenoids, rack and pinion mechanisms, linear screws, electrically controlled pneumatics or hydraulics, or other similarly situated actuators. As may be appreciated, translation of the drive axle 92, and the corresponding pivoting motion, may be operative to transition the wiper blade between the wiping position (not shown) and the parked position 42.

While FIGS. 3-6 are meant to be illustrative of various actuation techniques and/or mechanisms, it should be understood that the actuator 50 may employ other mechanism means to transition the wiper assembly 12 from a wiping position 40 to a parked position 42. Such means may include the use of actuated 4 (or more)-bar linkages, a translatable wedge/ramp that provides a lifting force to the armature, or other similar mechanisms.

As generally illustrated in FIGS. 3-6, the controller 54 may be responsive to an event signal 110. The event signal 110 may, for example, be a signal generated by a user event, such as, for example, depressing a button, toggling a switch, or turning a dial (i.e., actuation means performed by a user/passenger of the vehicle). As such, the controller 54 may be responsive to the actuation of the button/switch/dial by the user (and to corresponding event signal 110) to generate an electrical actuation signal 52, which may, in turn, cause the wiper blade 18 to transition between the wiping position 40 and the parked position 42.

In an embodiment, the event signal 110 may comprise a signal signifying a key-off event (i.e., the vehicle being transitioned to an “off” state, such as by transitioning an ignition-key to an “off” position). As such, the controller 54 may provide the electrical actuation signal 52 when the vehicle is in an “off” state. This configuration may be a more automatic actuation than relying on a user-driven event. As such, the controller 54 may be responsive to the key-off event to transition the wiper blade 18 between the wiping position 40 and the parked position 42. In a further configuration, the controller 54 may generate the electrical actuation signal 52 when it receives an indication of both a key-off event and a temperature condition. As such, the wiper blade 18 may be automatically be transitioned to the parked position 42 when the vehicle is off, and when the temperature either falls to a point where the blade 18 is in danger of freezing to the surface 14 or increases to a point where the blade 18 is in danger of melting/deforming on the surface 14.

While the best modes for carrying out the invention have been described in detail, particularly with respect to FIGS. 3-6, those familiar with the art to which this invention relates will recognize that various alternative actuator designs may be employed. It is intended that all matter contained in the above description or shown in the accompanying drawings shall be interpreted as illustrative only and not as limiting.

1. A vehicle wiper assembly comprising:
a wiper blade configured to wipe a surface;
an armature including a first end spaced from a second end, the armature coupled with the wiper blade at the first end, and coupled to a pivot mechanism at the second end, the pivot mechanism configured to allow the wiper blade and armature to articulate about the second end in a direction substantially away from the surface and between a wiping position and a parked position; and
an actuator in mechanical communication with the armature and configured to receive an electrical actuation signal;
wherein the wiper blade is in contact with the surface while in the wiping position, and the wiper blade is separated from the surface while in the parked position; and
wherein the actuator is configured to transition the wiper blade between the wiping position and the parked position in response to the received electrical actuation signal.

2. The vehicle wiper assembly of claim 1, wherein the actuator includes a shape memory alloy material having a crystallographic phase that is changeable between martensite and austenite in response to the electrical actuation signal.

3. The vehicle wiper assembly of claim 2, wherein the shape memory alloy material is a wire having a length, the wire being configured to contract in length in response to the electrical actuation signal.

4. The vehicle wiper assembly of claim 3, wherein the wire is in mechanical communication with the armature; and wherein a contraction of the length of the wire is operatively configured to transition the armature to articulate about the second end.

5. The vehicle wiper assembly of claim 1, wherein the actuator includes an extendable riser disposed between the armature and the surface, the riser having a height that is transitionable between a nominal position and an extended position in response to the electrical actuation signal; and
wherein the extendable riser is operative to lift a portion of the armature when transitioned to the extended position.

6. The vehicle wiper assembly of claim 1, wherein the actuator includes an articulating stand disposed between the armature and the surface, the stand configured to articulate between a collapsed position and a standing position in response to the electrical actuation signal; and
wherein the stand is operative to lift a portion of the armature when articulated to the standing position.

7. The vehicle wiper assembly of claim 1, further comprising a rotary hub coupled to the second end of the armature, the rotary hub having an axis of rotation and configured to articulate the wiper blade about the second end and in a direction substantially along the surface.

8. The vehicle wiper assembly of claim 7, wherein the actuator includes the rotary hub, the rotary hub being configured to translate along the axis of rotation to transition the wiper blade between the wiping position and the parked position.

9. The vehicle wiper assembly of claim 1, further comprising a controller configured to provide the electrical actuation signal.

10. The vehicle wiper assembly of claim 1, wherein the pivot mechanism is configured to selectively maintain the wiper blade in the parked position.

11. The vehicle wiper assembly of claim 1, further comprising a return mechanism configured to apply a force to the armature that urges the armature to rotate about the pivot mechanism in a direction toward the surface.

12. The vehicle wiper assembly of claim 11, wherein the force applied to the armature by the return mechanism is operative to cause the wiper blade to strike the surface.

13. A vehicle wiper assembly comprising:
a wiper blade configured to wipe a surface;
an armature including a first end spaced from a second end, the armature coupled with the wiper blade at the first end, and coupled to a pivot mechanism at the second end, the pivot mechanism configured to allow the wiper blade and armature to articulate about the second end in a direction substantially away from the surface and between a wiping position and a parked position; and
an actuator in mechanical communication with the armature and configured to receive an electrical actuation signal, the actuator including a shape memory alloy material having a crystallographic phase that is changeable between martensite and austenite in response to the electrical actuation signal;
wherein the wiper blade is in contact with the surface while in the wiping position, and the wiper blade is separated from the surface while in the parked position; and
wherein the shape memory alloy material has a length that is operatively configured to contract in response to the electrical actuation signal, and wherein the contraction in length is operatively configured to transition the wiper blade between the wiping position and the parked position.

14. The vehicle wiper assembly of claim 13, wherein the actuator includes an extendable riser disposed between the armature and the surface, the riser having a height that is transitionable between a nominal position and an extended position in response to the contraction in length of the shape memory alloy material; and
wherein the extendable riser is operative to lift a portion of the armature when transitioned to the extended position.

15. The vehicle wiper assembly of claim 13, wherein the actuator includes an articulating stand disposed between the armature and the surface, the stand and configured to articulate between a collapsed position and a standing position in response to the contraction in length of the shape memory alloy material; and
wherein the stand is operative to lift a portion of the armature when articulated to the standing position.

16. The vehicle wiper assembly of claim 13, further comprising a rotary hub coupled to the second end of the armature, the rotary hub having an axis of rotation and configured to articulate the wiper blade about the second end and in a direction substantially along the surface.

17. The vehicle wiper assembly of claim 16, wherein the actuator includes the rotary hub, the rotary hub being configured to translate along the axis of rotation in response to the contraction in length of the shape memory alloy material, the translation configured to transition the wiper blade between the wiping position and the parked position.

18. The vehicle wiper assembly of claim 13, further comprising a controller configured to provide the electrical actuation signal in response to an event signal.

19. The vehicle wiper assembly of claim 13, wherein the pivot mechanism includes a locking mechanism configured to selectively maintain the wiper blade in the parked position.

20. A vehicle wiper assembly comprising:
a wiper blade configured to wipe a surface;
an armature including a first end spaced from a second end, the armature coupled with the wiper blade at the first end, and coupled to a pivot mechanism at the second end, the pivot mechanism configured to allow the wiper blade and armature to articulate about the second end in a direction substantially away from the surface and between a wiping position and a parked position;
a controller configured to provide an electrical actuation signal in response to an event signal, the event signal indicative of a depressed button, a toggled switch, a turned dial, or an ignition key in an “off” position.
an actuator in mechanical communication with the armature and configured to receive the electrical actuation signal, the actuator being configured to transition the wiper blade between the wiping position and the parked position in response to the received electrical actuation signal; and
wherein the wiper blade is in contact with the surface while in the wiping position, and the wiper blade is separated from the surface while in the parked position.
